(19) United States
(12) Patent Application Publication
(10) Pub. No.: US 2006/0021997 A1
(43) Pub. Date: Feb. 2, 2006

(54) Heat sink for gas-fueled appliance

(75) Inventor: Chuan-Chuan Lin, Hsin Chu (TW)

Correspondence Address: NIKOLAI & MERSEREAU, P.A., 900 SECOND AVENUE SOUTH, SUITE 820, MINNEAPOLIS, MN, 55402, US

(73) Assignee: Ario Lin, Tortola (VG)

(21) Appl. No.: 10/909,876

(22) Filed: Aug. 2, 2004

(51) Int. Cl. B67D 5/62

(52) U.S. Cl. 222/146.2

(57) ABSTRACT

A gas-fueled appliance includes a shell, a can, a transmitter and a heat sink. The can is put in the shell. The burner is also put in the shell. The transmitter includes a valve connected with the can, a regulator connected with the valve and a pipe leading to the burner from the valve. The heat sink absorbs heat from air in the shell and transmits the heat to the pipe.

### BACKGROUND OF INVENTION

1. Field of Invention

The present invention relates to a gas-fueled appliance.

2. Related Prior Art

Referring to FIG. 10, a conventional gas-fueled appliance includes a shell 110, a handle 120, a burner 200, a can 300 and a transmitter 400. The burner 200 is put in the shell 110. The can 300 is put in the handle 120. The burner 200 includes a nozzle 210 put at an end and an aperture 250 defined in the other end. A holder 220 is provided at the shell 110 opposite to the nozzle 210. The holder 220 defines an aperture 240 through which thermoplastic glue can be fed. The aperture 250 is aligned with the aperture 240 so that the thermoplastic glue can be fed to the burner 200 from the holder 220. A trigger 230 is connected with the holder 220 so that the holder 220 is operable via pulling the trigger 230. The gas-fueled appliance includes an igniter 250 with an electrode (not shown) put in the burner 200. The igniter 250 includes a button (not numbered) for actuation thereof. The transmitter 400 is put between the burner 200 and the can 300. The transmitter 400 includes a valve 430 connected with the can 300, a regulator 420 connected with the valve 430, and a pipe 410 leading to the burner 200 from the valve 430. The can 300 defines an aperture 310 for receiving a joint (not numbered) of the valve 430. Gas is contained in the can 300 in the liquid state under high pressure. In use, the gas flows through the valve 430 and transforms to the gaseous state because of reduced pressure. The gas expands quickly so that it cools quickly. Some of the gas transforms to the solid state and blocks the valve 430.

The present invention is therefore intended to obviate or at least alleviate the problems encountered in prior art.

### SUMMARY OF INVENTION

According to the present invention, a gas-fueled appliance includes a shell, a can, a transmitter and a heat sink. The can is put in the shell. The burner is also put in the shell. The transmitter includes a valve connected with the can, a regulator connected with the valve and a pipe leading to the burner from the valve. The heat sink absorbs heat from air in the shell and transmits the heat to the pipe.

The primary advantage of the present invention is that the heat sink keeps the transmitter warm so that gas does not condense and block it.

Other objects, advantages, and novel features of the invention will become more apparent from the following detailed description when taken in conjunction with the drawings.

### BRIEF DESCRIPTION OF DRAWINGS

The present invention will be described through detailed illustration of several embodiments referring to the drawings.

FIG. 1 is a perspective view of a gas-fueled appliance according to a first embodiment of the present invention.

FIG. 2 is an exploded view of the gas-fueled appliance of FIG. 1.

FIG. 3 is side view of the gas-fueled appliance of FIG. 1 with a half of a shell removed.

FIG. 4 is an enlarged cross-sectional partial view of a heat sink of the gas-fueled appliance of FIG. 3.

FIG. 5 is side view of a gas-fueled appliance with a half of a shell removed according to a second embodiment of the present invention.

FIG. 6 is an enlarged cross-sectional partial view of a heat sink of the gas-fueled appliance of FIG. 5.

FIG. 7 is an enlarged cross-sectional partial view of a heat sink of the gas-fueled appliance according to a third embodiment of the present invention.

FIG. 8 is a perspective view of a gas-fueled appliance according to a fourth embodiment of the present invention.

FIG. 9 is a cross-sectional view taken along a line 9-9 in FIG. 8.

FIG. 10 is a side view of a conventional gas-fueled appliance with a half of a shell removed.

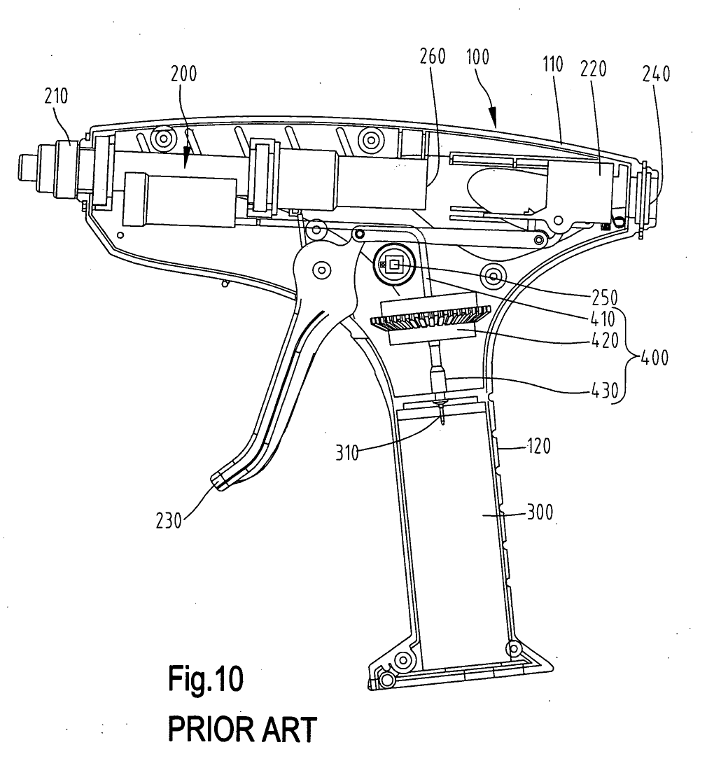

### DETAILED DESCRIPTION OF EMBODIMENTS

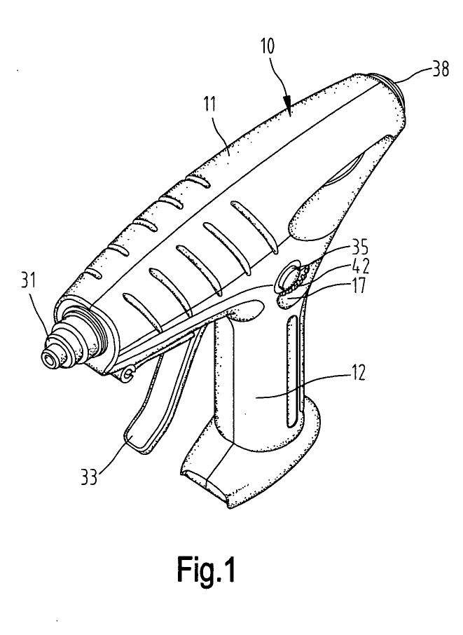

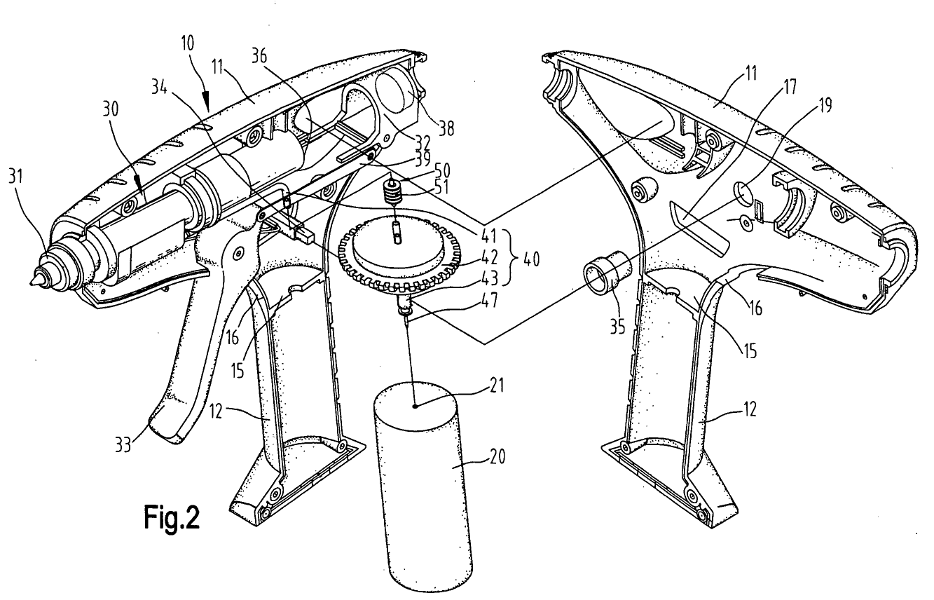

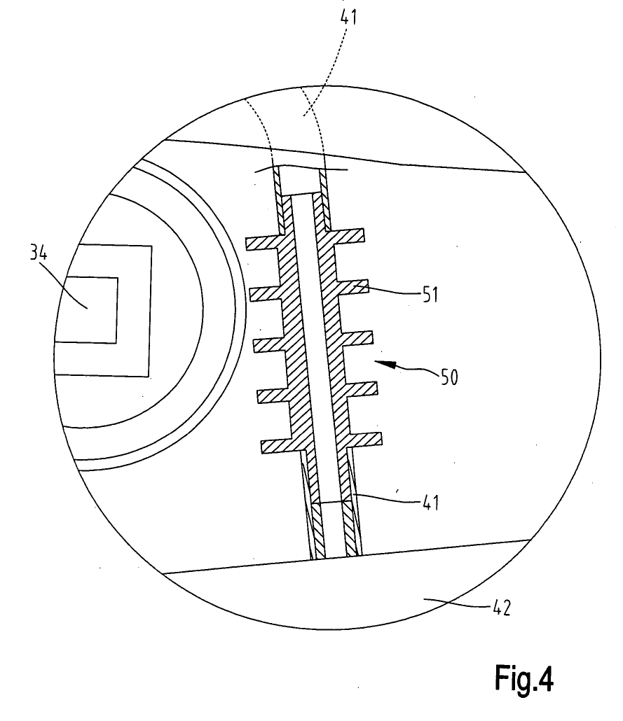

FIGS. 1 to 4 show a gas-fueled appliance in the form of a gluing gun for providing thermoplastic glue according to a first embodiment of the present invention. Referring to FIG. 1, the gas-fueled appliance includes a shell 10 consisting of two halves. The shell 10 includes a barrel 11 and a handle 12. Referring to FIG. 2, each half of the shell 10 includes a crescent partition 15 formed on internal side. As the halves of the shell 10 are assembled, the crescent partitions 15 make an annular partition for separating the barrel 11 from the handle 12. A recess 16 is defined in the edge of each half of the shell 10. As the halves of the shell 10 are assembled, the recesses 16 make an aperture through which a trigger 33 extends to the exterior from the interior of the shell 10. Each half of the shell 10 defines a slot 17. One half of the shell 10 defines an aperture 19.

Referring to FIG. 2, the gas-fueled appliance includes a can 20 put in the handle 12, a burner 30 put in the barrel 11, and a transmitter 40 for transmitting gas to the burner 30 from the can 20. The can 20 includes an aperture 21 defined therein.

The burner 30 includes a nozzle 31 formed at an end and an aperture 36 defined in an opposite end. A holder 32 is formed on an internal side of one half of the shell 10 opposite to the nozzle 31. The holder 32 defines an aperture 38 aligned with the aperture 36 so that thermoplastic glue (not shown) can be fed to the burner 30 from the holder 32. A lever 39 includes an end pivotally connected with the holder 32 and an opposite end pivotally connected with the trigger 33. Thus, the holder 32 is movable through pulling the trigger 33.

The gas-fueled appliance includes an igniter 34 located near the burner 30. An electrode (not shown) of the igniter 34 is put in the burner 30. The gas-fueled appliance includes a button 35 for actuating the igniter 34 in order to ignite the gas in the burner 30. The button 35 extends to the exterior from the interior of the shell 10 through the aperture 19.

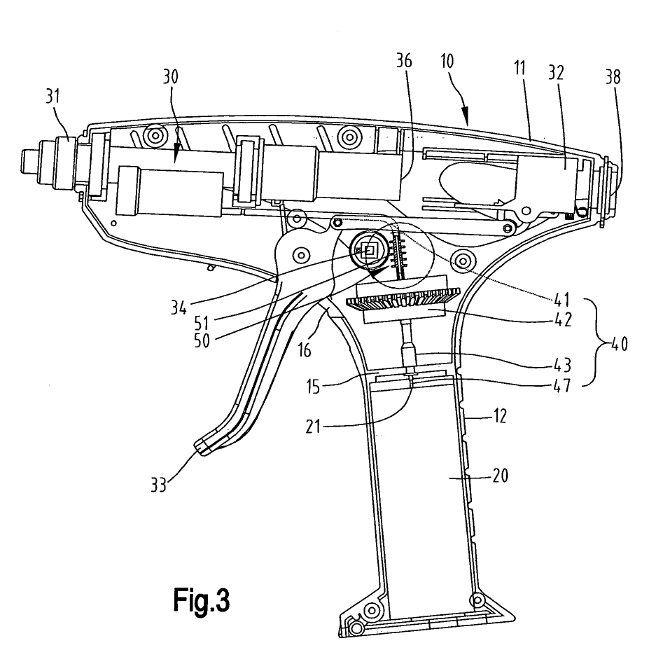

The transmitter 40 includes a valve 43 connected with the can 20, a regulator 42 connected with the valve 43, and a pipe 41 leading to the burner 30 from the valve 43. The valve 43 includes a first tube 47 inserted into the aperture 21 of the can 20 and an opposite second tube (not numbered) inserted into the pipe 41. The regulator 42 is used for controlling the flow rate of the gas to the burner 30. The valve 43 is held by means of the annular partition made of the crescent partitions 15 (see FIG. 3).

Referring to FIGS. 2 to 4, a heat sink 50 is connected with or put on the pipe 41. The heat sink 50 is in the form of a sleeve with several annular fins 51 formed thereon. The heat sink 50 absorbs heat from air in the shell 10 quickly and transmits the heat to the pipe 41. The heat sink 50 keeps the pipe 41 warm so that the gas is kept from condensing and blocking the pipe 41.

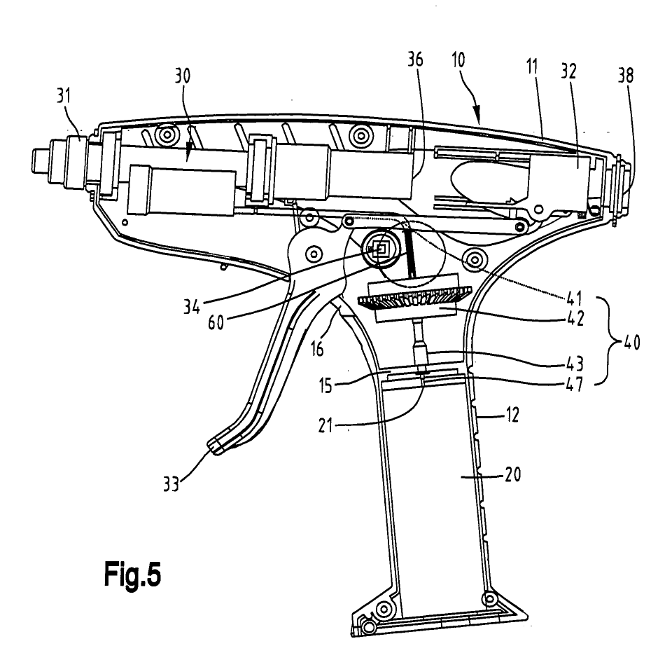

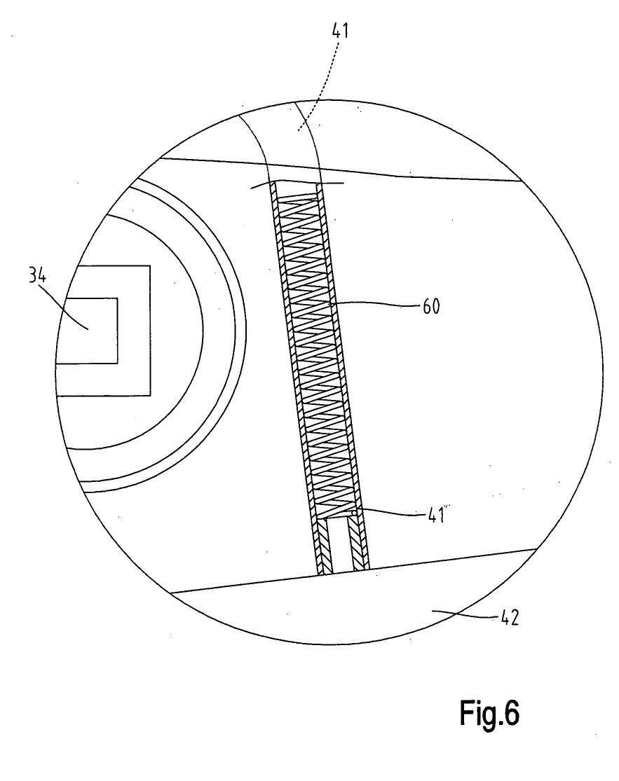

Referring to FIGS. 5 and 6, a gas-fueled appliance according to a second embodiment of the present invention will be described. The second embodiment is identical to the first embodiment but including a heat sink 60 instead of the heat sink 50. The heat sink 60 includes a spiral form. The heat sink 60 is put in the pipe 41. The heat sink 60 is located between the burner 30 and the regulator 42.

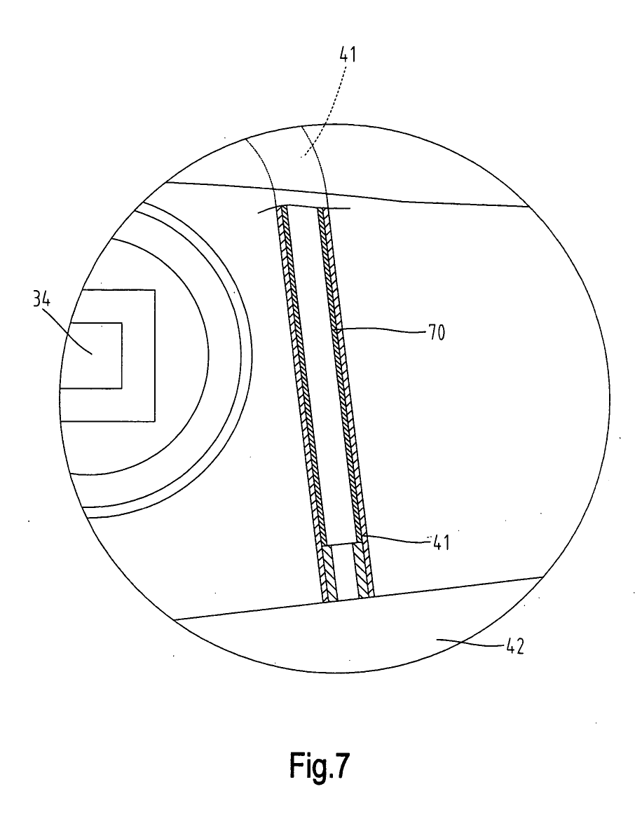

FIG. 7 shows a gas-fueled appliance according to a third embodiment of the present invention. The third embodiment is identical to the first embodiment but including a heat sink 70 instead of the heat sink 50. The heat sink 70 is in the form of a tube. The heat sink 70 is put in the pipe 41. The heat sink 70 is located between the burner 30 and the regulator 42.

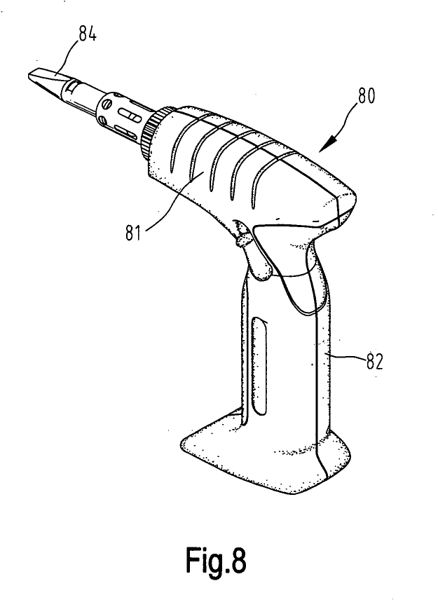

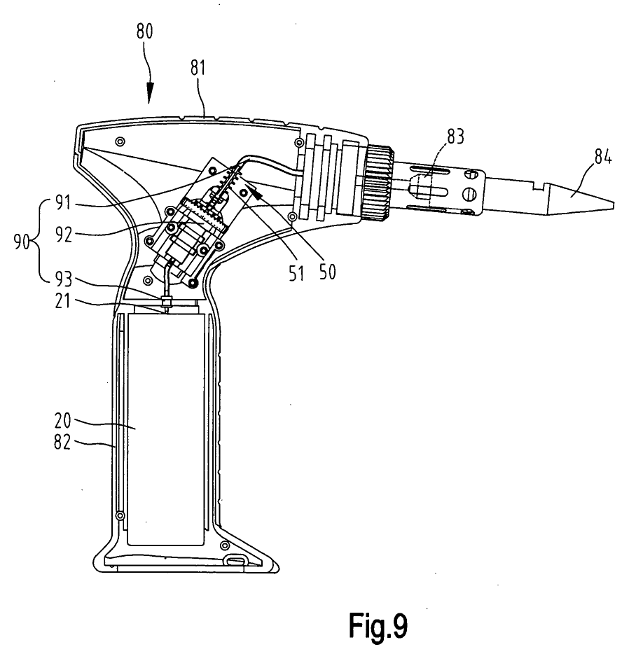

Referring to FIGS. 8 and 9, a gas-fueled appliance in the form of a welding gun according to a fourth embodiment of the present invention will be described. The gas-fueled welding gun includes a shell 80 consisting of two halves. The shell 80 includes a barrel 81 and a handle 82. The gas-fueled welding gun includes a can 20 put in the handle 82, a burner 83 put in the barrel 81 and a transmitter 90 for transmitting gas to the burner 83 from the can 20. The transmitter 90 includes a valve 93 connected with the can 20, a regulator 92 connected with the valve 93 and a pipe 91 leading to the burner 83 from the valve 93. The burner 83 includes an end connected with the pipe 91 and an opposite end connected with an iron 84. A heat sink 50 is installed on the pipe 91.

Although not shown, the heat sink 60 shown in FIGS. 5 and 6, and the heat sink 70 shown in FIG. 7 can be provided in the pipe 91.

The present invention has been described through detailed illustration of the embodiments. Those skilled in the art can derive variation from the embodiments without departing from the scope of the present invention. The embodiments hence shall not limit the scope of the present invention defined in the claims.

1. A gas-fueled appliance comprising:
a shell;
a can put in the shell;
a burner put in the shell;
a transmitter comprising a valve connected with the can, a regulator connected with the valve and a pipe leading to the burner from the valve; and
a heat sink located coextensively with the pipe and located intermediate the burner and the valve for absorbing heat from air in the shell and passing the heat to the pipe.

2. The gas-fueled welding gun according to claim 1 wherein the heat sink is separately formed from and directly connected with the pipe.

3. The gas-fueled welding gun according to claim 2 wherein the heat sink is put around and engages the pipe.

4. The gas-fueled appliance according to claim 3 wherein the heat sink is a sleeve with fins formed thereon, with the sleeve received on the pipe.

5. The gas-fueled appliance according to claim 4 wherein the fins are annular.

6. The gas-fueled appliance according to claim 2 wherein the heat sink is put in the pipe.

7. The gas-fueled appliance according to claim 6 wherein the heat sink is spiral.

8. The gas-fueled appliance according to claim 6 wherein the heat sink is tubular.

9. The gas-fueled appliance according to claim 1 wherein the shell includes a handle for receiving the can and a barrel for receiving the burner.

10. The gas-fueled appliance according to claim 1 wherein the gas-fueled appliance is a gluing gun for providing thermoplastic glue.

11. The gas-fueled appliance according to claim 10 comprising a trigger that can be pulled in order to feed thermoplastic glue.

12. The gas-fueled appliance according to claim 10 comprising a button that can be pushed in order to actuate the burner.

13. A gas-fueled welding gun comprising:
a shell;
a can put in the shell;
a burner put in the shell;
a transmitter comprising a valve connected with the can, a regulator connected with the valve, and a pipe leading to the burner from the valve; and
a heat sink located coextensively with the pipe and located intermediate the burner and the valve for absorbing heat from air in the shell and passing the heat to the pipe.

14. The gas-fueled welding gun according to claim 13 wherein the heat sink is separately formed from and directly connected with the pipe.

15. The gas-fueled welding gun according to claim 14 wherein the heat sink is put around and engages the pipe.

16. The gas-fueled welding gun according to claim 15 wherein the heat sink is a sleeve with fins formed thereon, with the sleeve received on the pipe.

17. The gas-fueled welding gun according to claim 16 wherein the fins are annular.

18. The gas-fueled welding gun according to claim 14 wherein the heat sink is put in the pipe.

19. The gas-fueled welding gun according to claim 18 wherein the heat sink is spiral.

20. The gas-fueled welding gun according to-claim 18 wherein the heat sink is tubular.
